(19) United States
(12) Patent Application Publication
(10) Pub. No.: US 2020/0240801 A1
(43) Pub. Date: Jul. 30, 2020

(54) SYSTEMS, METHODS, AND COMPUTER PROGRAM PRODUCT FOR ROUTE VALIDATION

(71) Applicant: HERE GLOBAL B.V., Eindhoven (NL)

(72) Inventors: Zhenhua ZHANG, Chicago, IL (US); Leon STENNETH, Chicago, IL (US)

(21) Appl. No.: 16/262,481

(22) Filed: Jan. 30, 2019

(51) Int. Cl. G01C 21/34

(52) U.S. Cl. CPC G01C 21/3461; G05D 1/0214

(57) ABSTRACT

A method, a system, and a computer program product are provided for validating one or more routes between at least a first road object and a second road object. The system, for example, comprises at least one non-transitory memory configured to store computer program code instructions; and at least one processor configured to execute the computer program code instructions. The processor may be configured to obtain at least a first map-matched link corresponding to the first road object and a second map-matched link corresponding to the second road object, and search for one or more downstream links, based on a plurality of first link attributes of the first map-matched link. The processor may be further configured to determine whether the second map-matched link is one among the one or more searched downstream links to obtain a result, and validate the one or more routes based on the result.

### TECHNOLOGICAL FIELD

The present disclosure generally relates to mapping and navigation systems, and more particularly relates to validating one or more routes between road objects in a geographical region.

### BACKGROUND

Various navigation applications are available to provide directions for driving, walking, or other modes of travel. Web sites and mobile applications offer map applications that allow a user to request directions from one point to another. Navigation devices based on Global Positioning System (GPS) technology have become common, and these systems are capable of determining the location of a device to provide directions to drivers, pedestrians, cyclists, and the like. Road signs placed on a road may guide and warn traffic on the road, including vehicles, bicycles, pedestrians etc. Road signs may serve to alert drivers to the speed limit for a particular roadway. They may also help bring attention to detours, construction work, and hazards, such as sharp turns and steep hills. As part of navigation process, it is important for users of vehicles and autonomous and semi-autonomous vehicles to detect road signs, such as, “men at work” sign, “roadwork ahead” sign etc., or temporary signs such as barrier boards, etc. with accurate positioning of these signs.

Accurate detection of road signs is relevant for navigation of autonomous vehicles. Providing environmental awareness for vehicle safety has been a primary concern for automobile manufacturers and related service providers. In vehicles, such as, autonomous vehicles, a plurality of sensors are installed to capture the road sign observations and road signs are learned from the road sign observations. However, with current sensors installed in the autonomous vehicles, the autonomous vehicles may not be able to detect road signs accurately. Detection of the extent of the road signs is subject to visibility, weather and lighting conditions, etc. Some vehicles may miss the lane markings while navigating through the road as other vehicles may be obstructing the view or the lane markings may be occluded by water, mud, or snow. Information related to connectivity of roads may be missing or unordered due to discrete observations of the lane markings or the road signs from a plurality of vehicles.

### BRIEF SUMMARY

Vehicles on a road typically rely on map databases that contain information regarding road geometry, lane geometry, road link connectivity, road type, etc. The information in the map databases may be enriched with data sources that provide traffic data, weather related data, and information related to road maintenance. A plurality of sensors, installed onboard the vehicles may provide information related to road objects to augment the content of the map databases or remote map data providers, alert the user of the vehicles of a hazardous condition or even provide input for controlling the vehicle in an autonomous or semi-autonomous manner. Accurate detection of the road objects is essential for navigation of vehicles, and providing environmental awareness for vehicle safety has been a primary concern for automobile manufacturers and related service providers. However, the accurate detection of the road objects is subject to visibility, weather, and lighting conditions. The vehicles may fail to detect a road object correctly due to sunlight being reflected in a particular manner at a time in a day or the lane markings may be occluded by water, mud, or snow. Moreover, the vehicles may collect point-based discrete observations of the road objects, and the discrete observations may provide an incomplete assessment of a route. It would be advantageous to validate routes between road objects for safety of the vehicles and trouble-free navigation. Accordingly, there is a need for validating at least one route between at least two road signs based on the discrete observations of the lane markings or the road signs for vehicles to better navigate through the road even under reduced visibility conditions.

A system, a method, and a computer program product are provided in accordance with an example embodiment described herein for validating one or more routes between at least a first road object and a second road object.

In one aspect, a system for validating one or more routes between at least a first road object and a second road object is disclosed. The system comprises at least one non-transitory memory configured to store computer program code instructions, and at least one processor configured to execute the computer program code instructions to: obtain at least a first map-matched link corresponding to the first road object and a second map-matched link corresponding to the second road object, search for one or more downstream links in downstream of the first map-matched link, based on a plurality of first link attributes of the first map-matched link, determine whether the second map-matched link is one among the searched downstream links, to obtain a result; and validate one or more routes between at least the first road object and the second road object, based on the result.

According to some example embodiments, the one or more downstream links comprise a first downstream link and a plurality of second downstream links in sequence. To search for one or more downstream links, The processor may be configured to search for the first downstream link based on the first link attributes and iteratively search for the plurality of second downstream links, based on a plurality of second link attributes of a respective preceding link of each of the plurality of second downstream links.

According to some example embodiments, the processor may be configured to generate route data corresponding to the one or more routes between at least the first road object and the second road object, based on the result that indicates that the second map-matched link is one among the one or more searched downstream links. In some example embodiments, the processor may be configured to generate on a user interface, a notification indicating one or more invalid routes between at least the first road object and the second road object, based on the result that indicates that the second map-matched link is excluded from the one or more searched downstream links.

To generate the route data, the processor may be configured to identify at least one start link as the first map-matched link and identify at least one end link as the second map-matched link.

The plurality of first link attributes of the first map-matched link may include a functional class of the first map-matched link, a link start location and a link end location of the first map-matched link, a link downstream heading of the first map-matched link, and a link length of the first map-matched link. The plurality of second link attributes may include a functional class of the respective preceding link of each of the plurality of second downstream links, a link start location and a link end location of the respective preceding link of each of the plurality of second downstream links, a link upstream heading of the respective preceding link of each of the plurality of second downstream links, and a link length of the respective preceding link of each of the plurality of second downstream links.

According to some example embodiments, the processor is configured to search for one or more downstream links in the downstream of the first map-matched link based on selection criteria. The selection criteria comprises a first condition that a sum total of link lengths of the first map-matched link and the one or more searched downstream links is less than or equal to a threshold length and a second condition that a heading difference between each pair of sequential links among the first map-matched link and the one or more searched downstream links is less than or equal to a threshold heading range.

According to some example embodiments, the processor is further configured to cluster a plurality of road object observations, based on an observation type, a location and a heading of each of the plurality of road object observations to generate at least one cluster and map-match the generated at least one cluster to a plurality of links based on the observation type, the location and the heading of each of the plurality of road object observations in the generated at least one cluster, to obtain at least the first map-matched link and the second map-matched link.

According to some example embodiments, each of at least the first road object and the second road object is one of a road sign, a physical divider, road markings, a bollard, a cone, a road barrier, a guardrail, and a broken down vehicle.

In another aspect, a method for validating one or more routes between at least a first road object and a second road object is disclosed. The method comprising obtaining by a processor, at least a first map-matched link corresponding to the first road object and a second map-matched link corresponding to the second road object, searching for one or more downstream links in downstream of the first map-matched link, based on a plurality of first link attributes of the first map-matched link; determining whether the second map-matched link is one among the searched downstream links, to obtain a result; and validating the routes between at least the first road object and the second road object, based on the result.

The downstream links comprise a first downstream link and a plurality of second downstream links in sequence. According to some example embodiments, for searching the downstream links, the method may further comprise searching for the first downstream link based on the first link attributes, and iteratively searching for the plurality of second downstream links, based on a plurality of second link attributes of a respective preceding link of each of the plurality of second downstream links.

According to some example embodiments, the method may further comprise generating route data corresponding to the routes between at least the first road object and the second road object, based on the result that indicates that the second map-matched link is one among the searched downstream links. According to some example embodiments, the method may further comprise generating a notification on a user interface indicating one or more invalid routes between at least the first road object and the second road object, based on the result that indicates that the second map-matched link is excluded from the searched downstream links.

According to some example embodiments, for generating of the route data, the method may further comprise identifying at least one start link as the first map-matched link and identifying at least one end link as the second map-matched link. According to some example embodiments, for obtaining at least the first map-matched link and the second map-matched link, the method may further comprise clustering a plurality of road object observations, based on an observation type, a location and a heading of each of the plurality of road object observations to generate at least one cluster and map-matching the generated at least one cluster to a plurality of links based on the observation type, the location and the heading of each of the plurality of road object observations in the generated at least one cluster.

In yet another aspect, a computer program product comprising at least one non-transitory computer-readable storage medium having stored thereon computer-executable program code instructions which when executed by a computer, cause the computer to carry out operations for validating one or more routes between at least a first road object and a second road object. The operations include: obtaining at least a first map-matched link corresponding to the first road object and a second map-matched link corresponding to the second road object; searching for one or more downstream links in downstream of the first map-matched link, based on a plurality of first link attributes of the first map-matched link; determining whether the second map-matched link is one among the searched downstream links, to obtain a result; and validating the one or more routes between at least the first road object and the second road object, based on the result.

According to some example embodiments, the operations further comprise searching for the first downstream link based on the first link attributes and iteratively searching for the plurality of second downstream links, based on a plurality of second link attributes of a respective preceding link of each of the plurality of second downstream links to search for the downstream links, wherein the downstream links comprise a first downstream link and a plurality of second downstream links in sequence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an exemplary scenario in which a system for validating one or more routes may be implemented, in accordance with one or more example embodiments;

FIG. 2 exemplarily illustrates a block diagram of the system for validating one or more routes between at least a first road object and a second road object;

FIG. 3 illustrates a block diagram of a working environment of the system exemplarily illustrated in FIG. 2, for validating one or more routes between at least the first road object and the second road object in accordance with one or more example embodiments;

FIG. 4 illustrates a flowchart illustrative of a method for validating one or more routes between at least the first road object and the second road object, in accordance with one or more example embodiments;

FIG. 5 illustrates a tabular representation depicting data symbols constituting a road object observation, in accordance with one or more example embodiments;

FIGS. 6A-6B illustrate schematic diagrams showing link attributes of each of the plurality of map-matched links constituting a route, in accordance with one or more example embodiments;

FIG. 7 illustrates a flowchart showing steps for searching one or more downstream links in the downstream of the first map-matched link, in accordance with one or more example embodiments; and

FIGS. 8A-8B illustrate scenarios for validating one or more routes between a first road object and a second road object by the system exemplarily illustrated in FIG. 2.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “link” may be used to refer to any connecting pathway including but not limited to a roadway, a highway, a freeway, an expressway, a lane, a street path, a road, an alley, a controlled access roadway, a free access roadway, and the like.

The term “speed funnel” may be used to refer to a group of two or more speed limit signs indicating a change in sign values of speed limit signs from one end of the speed funnel to the other.

The term “route” may be used to refer to a path from a source location to a destination location on any link.

The term ‘road objects’ may be used to refer to one or more of road signs, lane markings, physical dividers and the like.

The term ‘road object observation’ may be used to refer to observations captured about one or more of road signs, lane markings, physical dividers and the like.

### End of Definitions

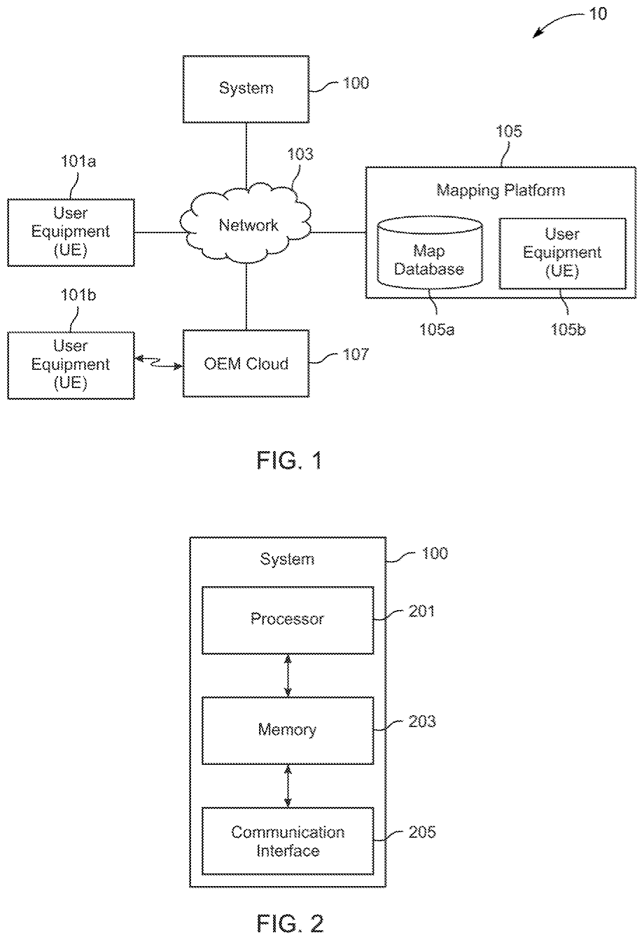

FIG. 1 illustrates an exemplary scenario 10 in which a system 100 for validating one or more routes may be implemented, in accordance with an example embodiment. A plurality of road objects may exist on the routes. The plurality of road objects may comprise at least two road objects, such as, a first road object and a second road object. The plurality of road objects may include one or more of road signs, for example, speed limit sign, street name sign, school sign, ‘men at work’ sign, a yellow lane marking, an underpass sign, an overpass sign, a road marking, or a lane marking, and the like, physical dividers, for example, guardrails, bollards, cones, and the like, broken down vehicles, and the like. A pair of road objects, for example, speed limit signs may constitute a speed funnel. The speed funnel may usually precede the roadwork zone. Each of the speed funnels may have an exclusive funnel ID. The speed limit signs in a speed funnel may have corresponding locations, corresponding headings, corresponding sign types, and corresponding sign values. In an embodiment, the speed limit signs in a speed funnel may have corresponding sign sides indicating the position of the speed limit signs relative to a pathway, in addition to the corresponding locations, corresponding headings, corresponding sign types, and corresponding sign values. Vehicles may detect the speed funnels and the lane markings along a pathway in the vicinity of a roadwork. A plurality of road object observations are captured by running vehicles and road objects are learnt from the road object observations. The locations of the road object observations are recorded as those of the vehicles when they recognize and track the objects. The detection of the road objects are discrete observations. That is, the detection of the road objects by the vehicles is point based observations indicating location co-ordinates of markings within an area.

The road signs may be static road signs or variable road signs positioned along the routes. Sign values of variable road signs may vary based on traffic conditions in vicinity of the variable road signs, such as, LCD display panels, LED panels, etc. The system 100 may be communicatively coupled to at least one user equipment 101A via a network 103. The system 100 may further be in communication with a mapping platform 105, via the network 103. At least one user equipment 101B may be communicatively connected to an OEM cloud 107 which in turn may be accessible to the system 100 via the network 103.

The user equipment (101A and 101B) may capture road object observations of road objects along the one or more routes. Additionally or optionally, the user equipment 101 may comprise a navigation application, that may be configured to provide route guidance and navigation related functions. The user equipment (101A and 101B) may comprise sensors to capture the road object observations, such as a camera for capturing images of road objects along the one or more routes, one or more position sensors to obtain location data of locations at which the images are captured, one or more orientation sensors to obtain heading data of the user equipment (101A, 101B) at the locations at which the images are captured, one or more motion sensors to obtain speed data of the user equipment (101A and 101B) at the locations at which the images are captured. In some example embodiments, the user equipment (101A and 101B) may comprise LIDAR sensors for capturing the road object observations.

In some example embodiments, the user equipment (101A and 101B) may be vehicles (autonomous, semi-autonomous, or manually driven) itself, or a part thereof. In some example embodiments, the user equipment (101A and 101B) may correspond to devices installed in a vehicle such as an infotainment system, a control system of the electronics, or a mobile phone connected with the control electronics of the vehicle. In some example embodiments, the system 100 may directly obtain the road object observations from the user equipment 101A. In some example embodiments, the road object observations may be accessible to the system 100 from the OEM cloud 107. For this purpose, the user equipment 101B may upload the captured road objects to the OEM cloud 107 sequentially or in batches which may then be bundled by the OEM cloud 107 for access by the system 100.

In some example embodiments, the user equipment (101A and 101B) may include a mobile computing device, such as, a laptop computer, a tablet computer, a mobile phone, a smart phone, a navigation unit, a personal data assistant, a watch, a camera, or the like. Additionally or alternatively, the user equipment (101A and 101B) may include a fixed computing device, such as, a personal computer. The user equipment 101A may be configured to access a mapping database 105A of the mapping platform 105 via a processing component 105B through, for example, a user interface of a mapping application, such that the user equipment 101A may provide navigational assistance to the user among other services provided through access to the mapping platform 105.

The network 103 may be a wired communication network, a wireless communication network, or any combination of wired and wireless communication networks, such as, cellular networks, Wi-Fi, internet, local area networks, or the like. In one embodiment, the network 103 may include one or more networks, such as, a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

As exemplarily illustrated, the map database 105A of the mapping platform 105, which may store node data, road segment data or link data, point of interest (POI) data, posted signs related data, or the like. The map database 105A may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road/link data and the node data may represent a road network, such as, used by vehicles, for example, cars, trucks, buses, motorcycles, and/or other entities. Optionally, the map database 105A may contain path segment and node data records or other data that may represent pedestrian paths or areas in addition to or instead of the vehicle road record data, for example. The road/link segments and nodes may be associated with attributes, such as geographic coordinates, street names, address ranges, speed limits, turn restrictions at intersections, and other navigation related attributes, as well as POIs, such as, fueling stations, hotels, restaurants, museums, stadiums, offices, auto repair shops, buildings, stores, parks, etc. The map database 105A may include data about the POIs and their respective locations in the POI records. The map database 105A may additionally include data about places, such as, cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 105A may include event data (e.g., traffic incidents, construction activities, scheduled events, unscheduled events, etc.,) associated with the POI data records or other records of the map database 105A associated with the mapping platform 105. The map database 105A may additionally include data related to road objects, such as, location of the road objects, diversions to be caused as indicated in the road objects, suggested routes to avoid congestion to be caused as indicated in the road objects, etc. The data related to road objects may be fetched from external systems, such as, roadwork planning system of the municipalities.

A content provider, such as, a map developer may maintain the mapping platform 105. By way of example, the map developer may collect geographic data to generate and enhance the mapping platform 105. There may be different ways used by the map developer to collect data. These ways may include obtaining data from other sources, such as municipalities or respective geographic authorities. In addition, the map developer may employ field personnel to travel by vehicle along roads throughout the geographic region to observe features and/or record information about them, for example. Crowdsourcing of geographic map data may also be employed to generate, substantiate, or update map data. For example, sensor data from a plurality of data probes, which may be, for example, vehicles traveling along a road network or within a venue, may be gathered and fused to infer an accurate map of an environment in which the data probes are moving. Such sensor data may be updated in real time such as on an hourly basis, to provide accurate and up to date map data. The sensor data may be from any sensor that may inform a map database of features within an environment that are appropriate for mapping. For example, motion sensors, inertia sensors, image capture sensors, proximity sensors, LIDAR (light detection and ranging) sensors, ultrasonic sensors etc. The gathering of large quantities of crowd-sourced data may facilitate the accurate modeling and mapping of an environment, whether it is a road segment or the interior of a multi-level parking structure. Also, remote sensing, such as aerial or satellite photography, may be used to generate map geometries directly or through machine learning as described herein.

The map database 105A of the mapping platform 105 may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, for example. The navigation-related functions may correspond to vehicle navigation, pedestrian navigation, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, etc. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

In some embodiments, the map database 105A may be a master geographic database configured at a server side, but in alternate embodiments, a client side map database 105A may represent a compiled navigation database that may be used in or with end user devices (e.g., the user equipment 101A and 101B) to provide navigation, speed adjustment and/or map-related functions to navigate through roadwork zones. The map database 105A may be used with the end user device, that is, the user equipment 101A to provide the user with navigation features. In such a case, the map database 105A may be downloaded or stored on the user equipment 101A which may access the mapping platform 105 through a wireless or wired connection, over the network 103.

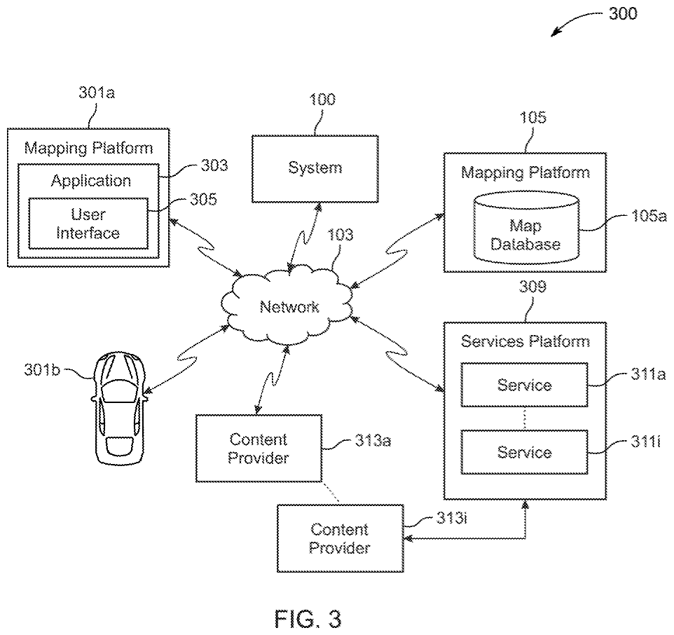

FIG. 2 exemplarily illustrates a block diagram of the system 100 for validating one or more routes between at least a first road object and a second road object for navigation assistance to a user of an autonomous or semi-autonomous vehicle. The system 100 may include a processing means, such as, at least one processor 201, a storage means, such as, at least one memory 203, and a communication means, such as, at least one communication interface 205. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

Additionally or alternatively, the processor 201 may include one or more processors capable of processing large volumes of workloads and operations to provide support for big data analysis. In an example embodiment, the processor 201 may be in communication with the memory 203 via a bus for passing information among components of the system 100. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein.

Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to users of the system 100 disclosed herein. The IoT related capabilities may in turn be used to provide smart city solutions by providing real time parking updates, big data analysis, and sensor-based data collection by using the cloud based mapping system for providing navigation and parking recommendation services. In some embodiments, the system 100 may be configured to provide an environment for development of parking strategy recommendation solutions for navigation systems in accordance with the embodiments disclosed herein. The environment may be accessed using the communication interface 205. The communication interface 205 may provide an interface for accessing various features and data stored in the system 100.

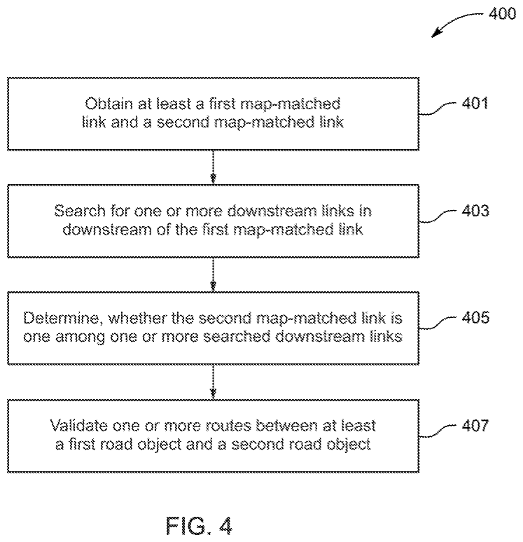

FIG. 3 describes a block diagram of a working environment 300 of the system 100 exemplarily illustrated in FIG. 2, for validating one or more routes between at least a first road object a second road object, in accordance with an exemplarily embodiment. The road objects along a pathway may be connected by one or more routes between them. The system 100 may validate the connectivity between the pair of the first road object and the second road object. In some example embodiments, the system may validate the connectivity between more than two road objects. The system 100 may be communicatively coupled to one or more user equipment 301A and 301B. In the exemplary environment 300 of FIG. 3, the user equipment 301A may be a smartphone that runs an application 303, such as, a navigation application on a user interface (UI) 305. The user equipment 301B may be considered to be a vehicle, such as, an autonomous, semi-autonomous, or a manually driven vehicle. An autonomous vehicle, as used throughout this disclosure, may refer to a vehicle having autonomous driving capabilities at least in some conditions. Although two user equipment are described herein, it may be contemplated that fewer or a greater number of user equipment may be present. In one embodiment, the system 100 may communicate with the user equipment 301A and 301B (through, for example, the communication interface 205), to obtain road object observations associated with a plurality of road objects, comprising the first road object and the second road object, along the pathway. In an alternative embodiment, the system 100 may obtain, via the communication interface 205, some or all of the road object observations from the OEM cloud 107 over the network 103. The processor 201 may further be configured to cluster the road object observations to generate clusters and map-match the generated clusters to a plurality of links. In one or more example embodiments, the processor 201 may obtain a plurality of map matched links corresponding to a plurality of road objects from the map database 105A over the network 103.

The road object observations may refer to sensor data collected from vehicles as sensors (for example, vehicle 301B). The sensor data may be generated on detection of static road objects positioned along the pathways. In an embodiment, the road object observations may refer to sensor data from digital or dynamic road signs, such as, LED panels, LCD panels, etc., positioned along the pathways. The road object observations may further comprise time of capture of the road object observations as a time stamp associated with each of the road object observations. A plurality of vehicles, such as, 301B passing by the location of each of the road objects on the pathway, may generate a plurality of road object observations for each of the road objects. Thus, each road object observation may be different from other road object observation based on location data, heading data, observation value, and observation type, and time of capture of the road object from a vehicle. The road object observations may further comprise location data of the vehicle at the time of capture of each of the road objects. Such location data may be acquired by suitable location sensors installed in the vehicle 301B. The location of the road object may thus correspond to the location of capture of the road object from the vehicle 301B.

In some example embodiments, the road object observations may further comprise motion data such as speed data of the vehicles such as the vehicle 301B at the instance of capture of each of the road object observations. Such motion data may be captured by one or more motion sensors (for example accelerometer) of the vehicle 301B. The vehicle 301B may thus include one or more sensors such as a camera, an acceleration sensor, a gyroscopic sensor, a LIDAR sensor, a proximity sensor, a motion sensor, a speed sensor and the like. The sensors may primarily be used for detecting road signs, determining speed and position of the vehicle 301B.

In one or more embodiments, the sensors may be built-in or embedded into or within interior of the vehicle 301B. In some embodiments, the vehicle 301B may use communication signals for position determination. The vehicle 301B may receive location data from a positioning system, a Global Navigation Satellite System, such as, Global Positioning System (GPS), Galileo, GLONASS, BeiDou, etc., cellular tower location methods, access point communication fingerprinting, such as, Wi-Fi or Bluetooth based radio maps, or the like. The data collected by the sensors may be used to gather information related to a road object, for example, a speed limit sign. In some embodiments, the vehicle 301B may have sensors positioned on or within itself and the sensors may provide data indicating a location and speed of the vehicle 301B, heading data associated with the vehicle 301B, observation types of the road objects, and object values of the road objects along pathways. The data collected by the sensors may be transmitted to the OEM cloud 107. The sensors, such as, the accelerometer, the gyroscope, and the like can be used to detect the location and heading of the vehicle, enabling a derived location and heading for the detected road object. The observation type may be a speed sign, a road sign indicating a roadwork zone, a road sign indicating a diversion ahead, a road sign indicating a speed bump ahead, etc. The observation value may indicate sign value associated with each of the road sign, such as, speed limit value, etc.

The system 100 may cluster the plurality of road object observations corresponding to the first road object and corresponding to the second road object, based on an observation type, a location and a heading of each of the plurality of road object observations to generate at least one cluster to generate learned road objects. In an embodiment, the system 100 may generate the cluster of the road object observations by applying spatial clustering methods, such as k-means or DBSCAN by setting pre-determined parameters for location clustering and/or heading clustering. In an embodiment, in the k-means clustering method, the learned road objects generated from the first plurality of road object observations are the clustering centroid of the generated cluster. The system 100 may further map-match the generated at least one cluster to a plurality of map-matched links in the map database 105A based on the observation type, the location, and the heading of each of the plurality of road object observations in the generated at least one cluster, to obtain at least a first map-matched link and a second map-matched link. The first map-matched link corresponds to the first road object and the second map-matched link corresponds to the second road object.

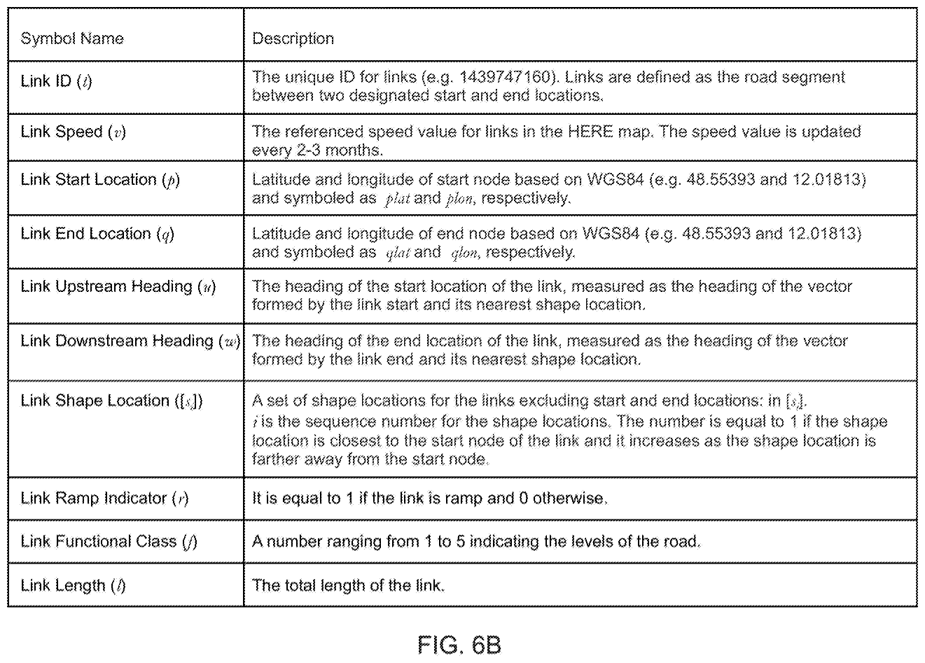

Each of the map-matched links, including the first map-matched link and the second map-matched link, may be associated with a LINK_ID, a link start location, a link end location, a link upstream heading, a link downstream heading, a link shape location, and a link length as exemplarily illustrated in FIGS. 6A-6B. A link start location refers to co-ordinates of position of a start node of a map-matched link. Similarly, a link end location refers to co-ordinates of position of an end node of a map-matched link. A link upstream heading refers to a heading of a link start location measured as a heading of a vector formed by the link start location and a shape location nearest to the link start location. A link downstream heading refers to a heading of a link end location measured as a heading of a vector formed by the link end location and a shape location nearest to the link end location. A link shape location refers to a set of shape locations of the map-matched links excluding the link start location and the link end location. A link length refers to a total length of a map-matched link.

In one embodiment, the user device or the user equipment 301A may be an in-vehicle navigation system, such as, an infotainment system, a personal navigation device (PND), a portable navigation device, a cellular telephone, a smart phone, a personal digital assistant (PDA), a watch, a camera, a computer, a workstation, and/or other device that may perform navigation-related functions, such as digital routing and map display. An end user of the user equipment 301A may request for navigation and map functions such as guidance and map display, for example, and for determination of one or more personalized routes or route segments based on one or more calculated and recorded routes, according to some example embodiments. In some embodiments, the system 100 may notify the user equipment 301A regarding the validity of routes between a first road object and a second road object. The validation of the routes between the first road object and the second road object is next discussed in detail in the subsequent embodiments.

Probe data collected by the vehicle 301B may be representative of the location of the vehicle 301B at a respective point in time and may be collected while the vehicle 301B is traveling along a route. While probe data is described herein as being vehicle probe data, example embodiments may be implemented with pedestrian probe data, marine vehicle probe data, or non-motorized vehicle probe data (e.g., from bicycles, skate boards, horseback, etc.). According to the example embodiment described below with the probe data being from motorized vehicles traveling along roadways, the probe data may include, without limitation, location data, (e.g. a latitudinal, longitudinal position, and/or height, GNSS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The vehicle 301B may comprise any device capable of collecting the aforementioned probe data.

The working environment 300 may further include a services platform 309, which may be used to provide navigation related functions and services 311a-311i to the application 303 running on the user equipment 301A. The services 311a-311i may include such as navigation functions, speed adjustment functions, traffic related updates, weather related updates, warnings and alerts, parking related services, indoor mapping services and the like. The services 311a-311i may be provided by a plurality of content providers 313a-313j. In some examples, the content providers 313a-313j may access various SDKs from the services platform 309 for implementing one or more services. In an example, the services platform 309 and the mapping platform 105 may be integrated into a single platform to provide a suite of mapping and navigation related applications for OEM devices, such as the user equipment 301A. The user equipment 301A may be configured to interface with the services platform 309, the content provider's services 313a-313j, and the mapping platform 105 over the network 103. Thus, the mapping platform 105 and the services platform 309 may enable provision of cloud-based services for the user equipment 301A, such as, storing the road object observations in an OEM cloud 107 in batches or in real-time and retrieving the stored road object observations for validating the routes between at least the first road object and the second road object.

The first map-matched link on which the first road object may be positioned and the second map-matched link on which the second road object may be positioned may be connected by a plurality of map-matched links that constitute the routes between the first road object and the second road object. The system 100 may further search for one or more downstream links in downstream of the first map-matched link based on a plurality of first link attributes of the first map-matched link, and determine whether the second map-matched link is one among the one or more searched downstream links, to obtain a result. The result may indicate whether the second map-matched link is connected to the first map-matched links via the searched downstream links. Based on the result, the system 100 may validate the routes between the first road object and the second road object.

The downstream links may include a first downstream link in the downstream of the first map-matched link and a plurality of second downstream links in sequence in the downstream of the first downstream link. Further, the system 100 may search for the first downstream link and iteratively search for the plurality of second downstream links. The system may search for the first downstream link in the downstream of the first map-matched link based on the first link attributes of the first map-matched link. That is, the first downstream link may be connected to the first map-matched link. The first link attributes may include a functional class of the first map-matched link, a link start location and a link end location of the first map-matched link, a link downstream heading of the first map-matched link, and a link length of the first map-matched link. The system 100 may search for the first downstream link based on selection criteria. The selection criteria include a first condition and a second condition. The first condition is that a sum total of link lengths of the first map-matched link and the first downstream link is less than or equal to a threshold length. The second condition is that a heading difference between the downstream heading of the first map-matched link and the upstream heading of the first downstream link is less than or equal to a threshold heading range.

The system 100 may iteratively search for the plurality of second downstream links in the downstream of the first downstream link, based on a plurality of second link attributes of a respective preceding link of each of the plurality of second downstream links. The second link attributes may include a functional class of the respective preceding link of each of the plurality of second downstream links, a link start location and a link end location of the respective preceding link of each of the plurality of second downstream links, a link downstream heading of the respective preceding link of each of the plurality of second downstream links, and a link length of the respective preceding link of each of the plurality of second downstream links. The system 100 may iteratively search for the second downstream links based on selection criteria. The first condition is that a sum total of link lengths of the first map-matched link, the first downstream link, and the plurality of second downstream links is less than or equal to a threshold length. The second condition is that a heading difference between the downstream heading of the respective preceding link and the upstream heading of the second downstream link is less than or equal to a threshold heading range.

The system 100 may determine the output of the search process to be one or more downstream links in the downstream of the first map-matched link. In some embodiments, the second map-matched link may be one among the searched downstream links. In some embodiments, the second map-matched link may be the first downstream link. In some embodiments, the second map-matched link may not be among the searched downstream links. The system 100 may determine whether the second map-matched link is one among the searched downstream links to obtain a result. Based on the result, the system 100 may validate the routes between the first road object and the second road object.

If the result indicates that the second map-matched link is one among the searched downstream links, the first road object and the second road object lie on one or more same routes and the routes between the first road object and the second road object may be valid. That is, the second map-matched link may be connected to the first map-matched link via a few of the searched downstream links. If the result indicates that the second map-matched link is excluded from the one or more searched downstream links, the first road object and the second road object may lie on one or more invalid routes.

On validation of the routes, the system 100 may, in some example embodiments, generate route data corresponding to the routes between the first road object and the second road object, if the routes are valid. The route data may include a start link and an end link of a valid route. The system 100 may identify the start link of a valid route as the first map-matched link and the end link of the valid route as the second map-matched link. In some example embodiments, the system 100 may generate a notification on the user interface 305 of the user equipment 301A indicating the routes between the first road object and the second road object to be invalid, if the routes are determined to be invalid.

On validating the one or more routes, the system 100 may provide navigation assistance to the vehicle 301B or to user of the vehicle 301B. The different representations of the navigation assistance may be in the form of a map with color coded or patterned road links indicating traffic conditions on the route, locations of route speed funnels on the route, etc. In an embodiment, the system 100 may receive destination information from the user on the user interface 305 of the user equipment 301A. In some example embodiments, the system 100 may notify the users of the vehicles, similar to 301B, via the user interface 305 of the user equipment 301A about a roadwork zone ahead based on the validated routes. In some example embodiments, the system 100 may render notification about changes in navigation routes due to roadwork zones ahead, broken down vehicles, cones, etc., and impact of the modified roadwork zones on parking situations, in mobile applications or navigation applications, such as, 303 used by the users.

In some embodiments, the system 100 may be configured to provide a repository of algorithms, in the memory 203, for implementing a plurality of location based services for navigation systems. For example, the system 100 may include algorithms related to geocoding, routing (multimodal, intermodal, and unimodal), clustering algorithms, machine learning in location based solutions, natural language processing algorithms, artificial intelligence algorithms, and the like. The data for the system 100 may be collected using a plurality of technologies including but not limited to drones, sensors, connected cars, cameras, probes, chipsets and the like. The collected data may be processed by the processor 201 of the system 100 to validate one or more routes according to the embodiments disclosed herein.

As noted above, the system 100 and/or the mapping platform 105 may be embodied by a processing component. However, in some embodiments, the system 100 and/or the mapping platform 105 may be embodied as a chip or chip set. In other words, the system 100 and/or the mapping platform 105 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The system 100 may therefore, in some cases, be configured to implement an example embodiment of the present invention on a single “system on a chip.” As such, in some cases, a chip or chipset may constitute a means for performing one or more operations for providing the functionalities described herein.

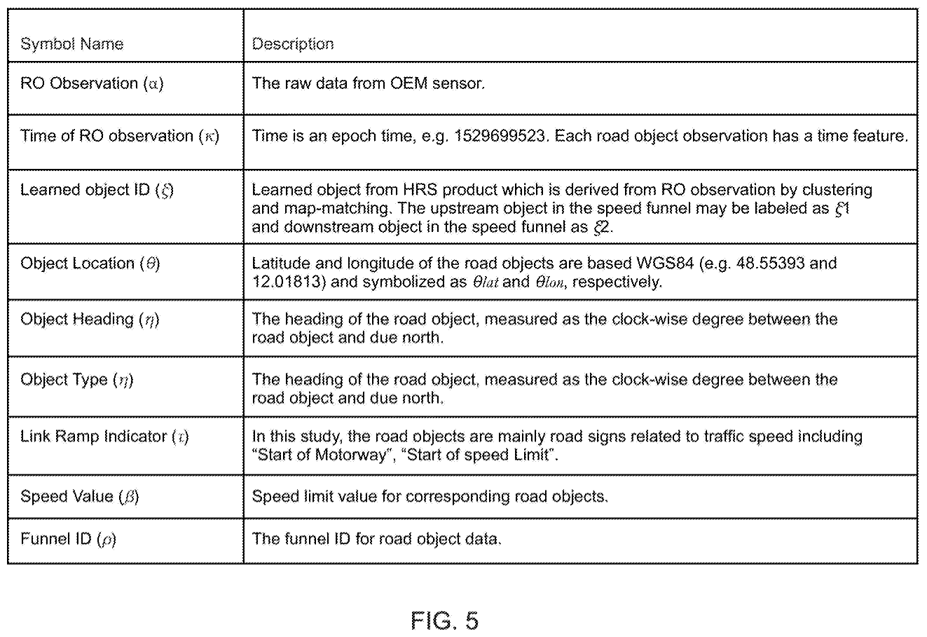

The user interface 305 of the user equipment 301A may in turn be in communication with the system 100 to provide output to the user and, in some embodiments, to receive an indication of a user input. In some example embodiments, the user interface 305 may communicate with the system 100 and displays input and/or output of the system 100. As such, the user interface 305 may include a display and, in some embodiments, may also include a keyboard, a mouse, a joystick, a touch screen, touch areas, soft keys, one or more microphones, a plurality of speakers, or other input/output mechanisms. In one embodiment, the system 100 may comprise user interface circuitry configured to control at least some functions of one or more user interface elements such as a display and, in some embodiments, a plurality of speakers, a ringer, one or more microphones and/or the like. The processor 201 and/or user interface circuitry comprising the processor 201 may be configured to control one or more functions of one or more user interface elements through computer program instructions (for example, software and/or firmware) stored on a memory accessible to the processor 201. In some example embodiments, the processor 201 may be configured to provide a method for validating one or more routes between at least the first road object and the second road object, as will be discussed in conjunction with FIG. 4 as below.

FIG. 4 illustrates a flowchart 400 illustrative of a method for validating one or more routes between at least the first road object and the second road object, according to example embodiments of the present invention. It will be understood that each block of the flowchart 400 of the method may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 100, employing an embodiment of the present invention and executed by a processor 201 of the system 100. As will be appreciated, any such computer program instructions may be loaded onto a computer or other programmable apparatus (for example, hardware) to produce a machine, such that the resulting computer or other programmable apparatus implements the functions specified in the blocks of the flowchart 400. These computer program instructions may also be stored in a computer-readable memory that may direct a computer or other programmable apparatus to function in a particular manner, such that the instructions stored in the computer-readable memory produce an article of manufacture, the execution of which implements the function specified in the blocks of the flowchart 400. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flowchart 400.

Accordingly, blocks of the flowchart 400 support combinations of means for performing the specified functions and combinations of operations for performing the specified functions for performing the specified functions. It will also be understood that one or more blocks of the flowchart 400, and combinations of blocks in the flowchart 400, may be implemented by special purpose hardware-based computer systems which perform the specified functions, or combinations of special purpose hardware and computer instructions.

The method illustrated by the flowchart 400 of FIG. 4 for validating the routes may include, at 401, obtaining by a processor (e.g. processor 201), at least a first map-matched link and a second map-matched link. The first map-matched link and the second map-matched link correspond to a first road object and a second road object, respectively. The first road object and the second road object may be one of a road sign, a physical divider, road markings, a bollard, a cone, a road barrier, a guardrail, or a broken down vehicle. At 403, the method may include searching for one or more downstream links in downstream of the first map-matched link, based on a plurality of first link attributes of the first map-matched link as disclosed in the detailed description of FIG. 3. The method may further include, at 405, determining whether the second map-matched link is one among the searched downstream links, to obtain a result. Further, the method 400, at 407, may include validating the routes between the first road object and the second road object, based on the result, as disclosed in the detailed description of FIG. 3.

Additionally, various other steps not shown in FIG. 4 may also be included in the method 400. The method 400 may further include generating route data corresponding to one or more routes between the first road object and the second road object, based on the result that indicates that the second map-matched link is one among the searched downstream links. The method 400 may include generating on a user interface, a notification indicating one or more invalid routes between the first road object and the second road object, based on the result that indicates that the second map-matched link is not one among the searched downstream links. If the routes are determined to be valid or invalid, the map database is updated accordingly.

In an embodiment, where the first road object and the second road object are two speed limit signs respectively, the first speed limit sign and the second speed limit sign may constitute a speed funnel. The validation of the routes may determine if the speed funnel formed by the speed limit signs is a route speed funnel, that is, the speed limit signs may be lying on a same route or different routes. In the route speed funnel, both the speed limit signs may be on a freeway or both the speed limit signs may be on a ramp or a service lane. If the speed funnel is a route speed funnel, the route speed funnel may be updated in the map database 105A for alerting the user about an approaching roadwork zone. In an embodiment, the vehicle may be converted from an autonomous mode to a manual mode of driving on the route based on the validated route speed funnel.

In an embodiment, where the first road object and the second road object are two bollards respectively, and if the two bollards are validated to be on the same route, the two bollards may indicate a road construction zone. The first bollard may indicate a start of roadwork on the route and the second bollard may indicate an end of roadwork on the route. In an embodiment, the start of roadwork, the end of roadwork, and the identification of the road construction zone may be indicated on the user interface 305.

In an embodiment, audio alerts or warnings or textual notifications may be generated on the user interface 305, indicating an approaching roadwork zone. In an embodiment, audio alerts or warnings or textual notifications may be generated on the user interface 305, indicating a recommendation regarding manual conversion of the vehicle from the autonomous mode to the manual mode of driving. In an embodiment, audio alerts or warnings or textual notifications may be generated on the user interface 305, indicating an automatic conversion of the vehicle from the autonomous mode to the manual mode.

The method of searching for the one or more downstream links, as depicted in step 403, may further comprise searching for the first downstream link based on the first link attributes; and iteratively searching for the plurality of second downstream links, based on a plurality of second link attributes of a respective preceding link of each of the plurality of second downstream links as disclosed in the detailed description of FIG. 3.

The obtaining of the first map-matched link and the second map-matched link, as disclosed in step 401 of the method may include clustering a plurality of road object observations, based on an observation type, a location and a heading of each of the plurality of road object observations to generate at least one cluster; and map-matching the generated at least one cluster to a plurality of links based on the observation type, the location and the heading of each of the plurality of road object observations in the generated at least one cluster.

In an example embodiment, a system for performing the method of FIG. 4 above may comprise a processor (e.g. the processor 201) configured to perform some or each of the operations (401-407) described above. The processor may, for example, be configured to perform the operations (401-407) by performing hardware implemented logical functions, executing stored instructions, or executing algorithms for performing each of the operations. Alternatively, the system may comprise means for performing each of the operations described above. In this regard, according to an example embodiment, examples of means for performing operations 401-407 may comprise, for example, the processor 201 and/or a device or circuit for executing instructions or executing an algorithm for processing information as described above.

On implementing the method disclosed herein, the end result generated by the system 100 is a tangible validation of one or more routes between road objects and generation of corresponding route data. Roadwork zones are preceded by speed funnels, lane markings, traffic cones, etc. The validation of a route through a speed funnel indicating a roadwork zone aids in smooth and well planned navigation of vehicles through the roadwork zone. The generation of the route data corresponding to a route through the speed funnel prior to navigation of an autonomous vehicle through the roadwork zone aids the autonomous vehicles in transitioning from an autonomous mode to a manual mode smoothly. In a roadwork zone, operating the autonomous vehicle in the manual mode is preferred to avoid any undue mishaps or collisions from taking place. In the process of validation of the routes between the road objects, the system 100 may overcome the shortcomings of the point based observations and failure in detection of some road objects by determining connectivity between map-matched links generated from the obtained road object observations. The generation of the route data corresponding to the routes through the roadwork zone may be based on randomly distributed locations of the road objects, which may be a few hundred meters away or a few tens of meters away from each other, captured by the vehicles.

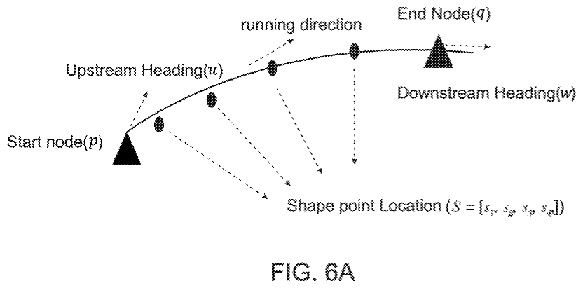

FIG. 5 illustrates a tabular representation depicting data symbols constituting a road object observation, in accordance with an exemplary embodiment of the present invention. As exemplarily illustrated in FIG. 5, a road object observation may represent raw data received from OEM sensors installed in vehicles, such as, 301B. The road object observations a may be referred to the discrete road object observations, characterized by the location of capture of the road object that is specified as a coordinate pair. The point-based road object observations include road object type, road object location, and road object heading as attributes. Each road object observation may have a time feature κ that may denote time of capture of the road object observation. The road object type may be a lane marking, a road sign, a bollard, a cone, a physical divider, a guardrail, etc. The road object location may be given as coordinate pair of (lat, lon), and the road object heading may be indicated in degrees.

The road object observations are clustered to generate a learned road object with a learned object ID ξ. For example, a learned object corresponding to a first road object may be labeled as ξ₁ and a learned object corresponding to a first road object may be labeled as ξ₂. Further, the location θ of the learned road object latitude and longitude of each learned road object may be symbolized as θlat and θlon, respectively. The heading η corresponding to each learned road object may be measured as the clock-wise degree between the road object on a pathway and due north. The sign type τ associated with the learned road object may be related to traffic speed including “Start of Motorway”, “Start of speed Limit”. The learned road object of the sign type related to traffic speed may constitute a speed funnel. A speed value β of each learned road object in a speed funnel may indicate speed limit value of corresponding road objects positioned along the pathway. The speed funnel may be identified by a funnel ID ρ. The learned road objects constituting a speed funnel will be associated with a same funnel_ID.

FIGS. 6A-6B illustrate schematic diagrams showing link attributes of each of the plurality of map-matched links constituting a route, in accordance with an exemplary embodiment of the present invention. The processor 201 may obtain the plurality of map-matched links, on clustering the road object observations with data symbols as exemplarily illustrated in FIG. 5. The map-matched links are formed from the road object observations corresponding to a cluster. Each of the map-matched links has a corresponding LINK_ID. As exemplarily illustrated in FIG. 6A, a map-matched link has a start node with link start location p, an end node with link end location q, a link upstream heading u, a link downstream heading w, multiple shape points with corresponding link shape locations [si], and a link length l as defined in FIG. 6B. As exemplarily illustrated in FIG. 6A, the map-matched link has four shape points with corresponding shape locations s1, s2, s3, and s4.

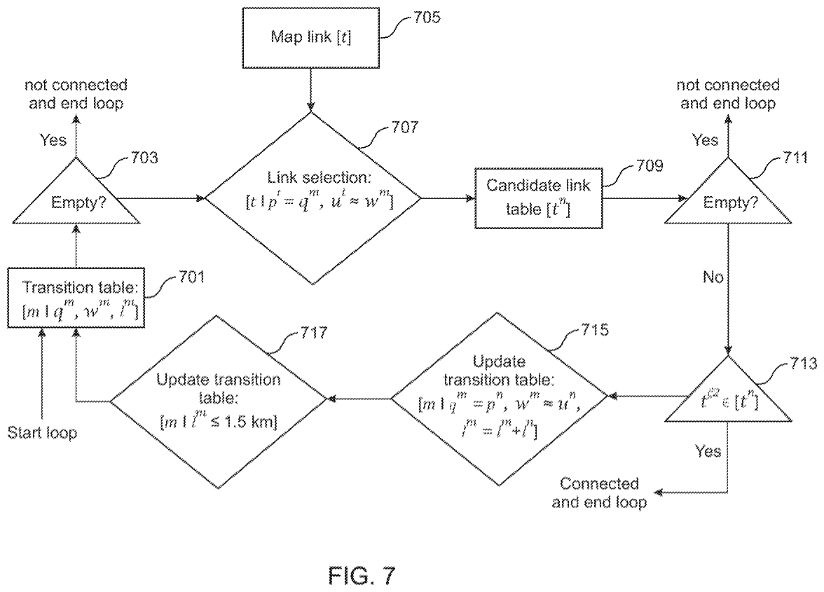

FIG. 7 illustrates a flowchart 700 showing steps for searching one or more downstream links in the downstream of the first map-matched link, in accordance with one or more example embodiments. The processor 201 of the system 100 may store temporary information comprising a plurality of link attributes of searched map-matched links in the map database 105A in a transition table of the map database 105A. As depicted in FIG. 7, at step 701, the processor 201 may initialize the plurality of link attributes in the transition table with a few of the first link attributes, such as, a link end location q^{m} of the first map-matched link and a link downstream heading w^{m} of the first map-matched link. A value of 0 is assigned to link length l^{m} at this step. At step 703, the processor 201 may communicate with the map database 105A and may determine if the transition table is empty. If the transition table is empty, the processor 201 may terminate the process of searching for one or more downstream links in the downstream of the first map-matched link, since there is no first map-matched link in the transition table for which downstream links need to be searched. On the other hand, if the transition table is not empty, the processor 201 may continue to search for one or more downstream links in the downstream of the first map-matched link with a few of the first link attributes stored in the transition table.

At step 705, the processor 201 may obtain map-matched links identified with LINK_IDs [t] from the map database 105A. The first map-matched link is identified with a LINK_ID t^{ξ1} and the second map-matched link is identified with a LINK_ID t^{ξ2}. The map-matched links may include one more downstream links in the downstream of the map-matched link. At step 707, the processor 201 may select a plurality of candidate first downstream links [tⁿ] connected to the first map-matched link based on the first link attributes stored in the transition table. At this step, the processor 201 may determine the candidate first downstream links whose link start location p^{t} may be same as the link end location q^{m} of the first map-matched link and whose upstream heading u^{t} may be similar to the downstream heading w^{m} of the first map-matched link. That is, the heading difference between the upstream heading u^{t} of each of the candidate first downstream links and the downstream heading w^{m} of the first map-matched link is not larger than 70 degrees. At step 709, the processor 201 may store the candidate first downstream links [tⁿ] in a candidate link table in the map database 105A since a second condition of the selection disclosed in the detailed description of FIG. 3 is satisfied. Further, the processor 201, at step 711, may determine if the candidate link table is empty. If the candidate link table is empty, the processor 201 may terminate the process for searching of the downstream links in the downstream of the first map-matched link. Since the candidate link table is not empty, that is, the candidate first downstream links [tⁿ] in the downstream of the first map-matched link are determined in step 709, the processor 201 may move to step 713.

At step 713, the processor 201 may determine if the second map-matched link with the LINK_ID t^{ξ2} is one among the candidate first downstream links [tⁿ] stored in the candidate link table. If the second map-matched link is one among the candidate first downstream links, the processor 201 may end the process at step 713 and conclude that the first map-matched link is connected to the second map-matched link. If the second map-matched link is not among the candidate first downstream links, at step 715, the processor 201 may update the first link attributes of the first map-matched link stored in the transition table with link attributes of the candidate first downstream links. That is, the processor stores the link end location q^{m} of the first map-matched link as the link start location pⁿ of each of the candidate first downstream links, the link downstream heading w^{m} of the first map-matched link is updated with link upstream heading uⁿ of each of the candidate first downstream links, and total link length l^{m} as a total length of the first map-matched link l^{m} and a link length of each of the candidate first downstream links lⁿ. On adding the link length of each of the candidate first downstream links to the link length of the first map-matched link l^{m}, at step 717, the processor 201 may determine whether the total link length l^{m} is less than or equal to a threshold length (for example, 1.5 km). If the total link length l^{m} is within 1.5 km, the processor 201 selects the first downstream link to be on a route towards the second road object. The processor 201 may update the transition table with the link attributes of the selected first downstream link. The processor 201 discards the other candidate first downstream links. Since the total link length l^{m} is within 1.5 km, the processor 201 may continue to iteratively search for a plurality of second downstream links in the downstream of the selected first downstream link in next cycles of execution of the flowchart to reach the second map-matched link. The processor 201 may utilize the updated transition table to search for a plurality of second downstream links connected to the selected first downstream link. In case, the total link length l^{m} is greater than 1.5 km, the processor 201 ends the search for downstream links and concludes that the second road object is not on the same route as the first road object.

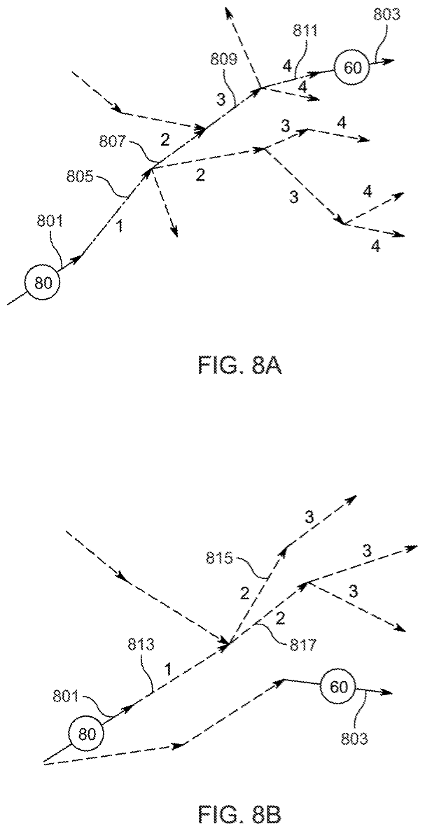

FIGS. 8A-8B illustrate scenarios for validating one or more routes between a first road object and a second road object by the system 100 exemplarily illustrated in FIG. 2. As exemplarily illustrated in FIGS. 8A-8B, the first road object and the second road object may constitute a speed funnel, where the first road object is a speed limit sign with a sign value 80 and the second road object is a speed limit sign with a sign value 60. The speed limit sign 80 is positioned on a first map-matched link 801 and the speed limit sign 60 is positioned on a second map-matched link 803. As disclosed in the detailed description of FIG. 3, the processor 201 may obtain map-matched links 801 and 803 associated with the two learned speed limit road signs 80 and 60. The processor 201 of the system 100 may search for downstream links in the downstream of the first map-matched link 801.

Using the first map-matched link 801 of the first speed limit sign, the method starts from building the transition table and extracting the candidate table in the first cycle of loop. The processor 201 of the system 100 may find all the possible downstream links connected to the links in the candidate table until the threshold length is reached or the second map-matched link 803 is found. When updating the transition table, the processor 201 stores the downstream links connected to the links in candidate table within a heading and total distance constraint.

As exemplarily illustrated in FIG. 8A, the processor 201 may obtain a first downstream link 805 based on the first link attributes of the first map-matched link 801 as disclosed in the detailed description of FIG. 3. The first downstream link 805 is examined for satisfying the selection criteria disclosed in the detailed description of FIG. 7. The processor 201 may determine if the first downstream link 805 is same as the second map-matched link 805. Since the first downstream link is not same as the second map-matched link, the processor 201 may search for one or more second downstream links in the downstream of the first downstream link 805, in the second iteration. The numerals next to the links in the FIGS. 8A-8B indicate the iteration number.

The processor 201 may find two downstream links in the downstream of the first downstream link 805 connected to the first downstream link 805 based on a plurality of second link attributes of the first downstream link 805. Based on the selection criteria, the processor 201 may select the second downstream link 807 to be on a route towards the second speed limit sign. In the third iteration, the fourth iteration, and the fifth iteration, the processor 201 may determine the downstream links 809, 811, and 803. At the end of each iteration, the processor 201 may determine whether the second map-matched link 803 is one among the obtained second downstream links. At the end of the 5^{th} iteration, since the processor 201 may determine that the second map-matched link 803 is one among the obtained second downstream links, the processor 201 concludes that the speed limits signs 80 and 60 are on a same route and the route between the speed limit signs 80 and 60 is valid.

Similarly, in FIG. 8B, the processor 201 may obtain a first downstream link 813 in the downstream of the first map-matched link 801. In the second iteration, the processor 201 may obtain a plurality of second downstream links in the downstream of the first downstream link. The processor may examine the obtained second downstream links for satisfying the selection criteria. Since the selection criteria is satisfied for the second downstream links 815 and 817, the processor 201, at the end of the 2^{nd} iteration, the processor 201 may determine whether the second map-matched link 803 is one among the obtained second downstream links 815 and 817. Since the processor 201 may determine that the second map-matched link 803 is not one among the obtained second downstream links 815 and 817, the processor 201 may continue to search for second downstream links in the downstream of the second downstream links 815 and 817 in the third iteration. At the end of the 3^{rd} iteration, the processor 201 may determine that the second map-matched link 803 is not one among the obtained second downstream links. The sum total of link lengths of the second downstream links, the first downstream link 813, and the first map-matched link 801 may be greater than the threshold length, at the end of the 3^{rd} iteration. The processor may stop the search for the second downstream links further after the 3^{rd} iteration. The processor 201 may conclude that the speed limits signs 80 and 60 are not on the same route and the route between the speed limit signs 80 and 60 is not valid. The processor 201 may generate a notification on the user interface 305 that the route between the road sign 80 and the road sign 60, as exemplarily illustrated in FIG. 8B, is invalid.

In this way, example embodiments of the present invention may result in validation of one or more routes between at least two road objects. The present invention enables to determine whether two road objects (for example, two road signs) are on the same route. In many instances, capturing of road object observations may be inaccurate and location of the learned road objects may be erroneously determined. For example, for a speed funnel indicating a roadwork zone, if the locations speed limit signs of the speed funnel on a road are not accurately determined by an autonomous vehicle, the navigation assistance provided to the vehicle may be troublesome. In such a scenario, validation of the routes may mitigate road accidents.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for validating one or more routes between at least a first road object and a second road object, the system comprising:
at least one non-transitory memory configured to store computer program code instructions; and
at least one processor configured to execute the computer program code instructions to:
obtain at least a first map-matched link corresponding to the first road object and a second map-matched link corresponding to the second road object;
search for one or more downstream links in downstream of the first map-matched link, based on a plurality of first link attributes of the first map-matched link;
determine whether the second map-matched link is one among the one or more searched downstream links, to obtain a result; and
validate the one or more routes between at least the first road object and the second road object, based on the result.

2. The system of claim 1,
wherein the one or more downstream links comprise a first downstream link and a plurality of second downstream links in sequence,
wherein to search for the one or more downstream links, the at least one processor is further configured to:
search for the first downstream link based on the first link attributes; and
iteratively search for the plurality of second downstream links, based on a plurality of second link attributes of a respective preceding link of each of the plurality of second downstream links.

3. The system of claim 2, wherein the plurality of second link attributes comprise a functional class of the respective preceding link of each of the plurality of second downstream links, a link start location and a link end location of the respective preceding link of each of the plurality of second downstream links, a link downstream heading of the respective preceding link of each of the plurality of second downstream links, and a link length of the respective preceding link of each of the plurality of second downstream links.

4. The system of claim 1, wherein the at least one processor is further configured to one of:
generate route data corresponding to the one or more routes between at least the first road object and the second road object, based on the result that indicates that the second map-matched link is one among the one or more searched downstream links; or
generate on a user interface, a notification indicating one or more invalid routes between at least the first road object and the second road object, based on the result that indicates that the second map-matched link is excluded from the one or more searched downstream links.

5. The system of claim 4, wherein to generate the route data, the at least one processor is further configured to:
identify at least one start link as the first map-matched link; and
identify at least one end link as the second map-matched link.

6. The system of claim 1, wherein the plurality of first link attributes of the first map-matched link comprise a functional class of the first map-matched link, a link start location and a link end location of the first map-matched link, a link downstream heading of the first map-matched link, and a link length of the first map-matched link.

7. The system of claim 1, wherein the at least one processor is further configured to search for the one or more downstream links in the downstream of the first map-matched link, based on a selection criteria wherein the selection criteria comprises:
a first condition that a sum total of link lengths of the first map-matched link and the one or more searched downstream links is less than or equal to a threshold length; and
a second condition that a heading difference between each pair of sequential links among the first map-matched link and the one or more searched downstream links is less than or equal to a threshold heading range.

8. The system of claim 1, wherein to obtain at least the first map-matched link and the second map-matched link, the at least one processor is further configured to:
cluster a plurality of road object observations, based on an observation type, a location and a heading of each of the plurality of road object observations to generate at least one cluster; and
map-match the generated at least one cluster to a plurality of links based on the observation type, the location and the heading of each of the plurality of road object observations in the generated at least one cluster, to obtain at least the first map-matched link and the second map-matched link.

9. The system of claim 1, wherein each of at least the first road object and the second road object is one of a road sign, a physical divider, road markings, a bollard, a cone, a road barrier, a guardrail, or a broken down vehicle.

10. A method for validating one or more routes between at least a first road object and a second road object, the method comprising:
obtaining by a processor, at least a first map-matched link corresponding to the first road object and a second map-matched link corresponding to the second road object;
searching by the processor, for one or more downstream links in downstream of the first map-matched link, based on a plurality of first link attributes of the first map-matched link;
determining by the processor, whether the second map-matched link is one among the one or more searched downstream links, to obtain a result; and
validating by the processor, the one or more routes between at least the first road object and the second road object, based on the result.

11. The method of claim 10,
wherein the one or more downstream links comprise a first downstream link and a plurality of second downstream links, and
wherein the searching for the one or more downstream links further comprises:
searching for the first downstream link based on the first link attributes; and
iteratively searching for the plurality of second downstream links, based on a plurality of second link attributes of a respective preceding link of each of the plurality of second downstream links.

12. The method of claim 11, wherein the plurality of second link attributes comprise a functional class of the respective preceding link of each of the plurality of second downstream links, a link start location and a link end location of the respective preceding link of each of the plurality of second downstream links, a link downstream heading of the respective preceding link of each of the plurality of second downstream links, and a link length of the respective preceding link of each of the plurality of second downstream links.

13. The method of claim 10, further comprising one of:
generating route data corresponding to the one or more routes between at least the first road object and the second road object, based on the result that indicates that the second map-matched link is one among the one or more searched downstream links; or
generating on a user interface, a notification indicating one or more invalid routes between at least the first road object and the second road object, based on the result that indicates that the second map-matched link is excluded from the one or more searched downstream links.

14. The method of claim 13, wherein the generating of the route data comprises:
identifying at least one start link as the first map-matched link; and
identifying at least one end link as the second map-matched link.

15. The method of claim 10, wherein the plurality of first link attributes of the first map-matched link comprise a functional class of the first map-matched link, a link start location and a link end location of the first map-matched link, a link downstream heading of the first map-matched link, and a link length of the first map-matched link.

16. The method of claim 10, wherein the searching for the one or more downstream links in the downstream of the first map-matched link is based on a selection criteria, wherein the selection criteria comprises:
a first condition that a sum total of link lengths of the first map-matched link and the one or more searched downstream links is less than or equal to a threshold length; and
a second condition that a heading difference between each pair of sequential links among the first map-matched link and the one or more searched downstream links is less than or equal to a threshold heading range.

17. The method of claim 10, wherein the obtaining of at least the first map-matched link and the second map-matched link comprises:
clustering a plurality of road object observations, based on an observation type, a location and a heading of each of the plurality of road object observations to generate at least one cluster; and
map-matching the generated at least one cluster to a plurality of links based on the observation type, the location and the heading of each of the plurality of road object observations in the generated at least one cluster, to obtain at least the first map-matched link and the second map-matched link.

18. The method of claim 10, wherein each of at least the first road object and the second road object is one of a road sign, a physical divider, road markings, a bollard, a cone, a road barrier, a guardrail, or a broken down vehicle.

19. A computer program product comprising at least one non-transitory computer-readable storage medium having stored thereon computer-executable program code instructions which when executed by a computer, cause the computer to carry out operations for validating one or more routes between at least a first road object and a second road object, the operations comprising:
obtaining at least a first map-matched link corresponding to the first road object and a second map-matched link corresponding to the second road object;
searching for one or more downstream links in downstream of the first map-matched link, based on a plurality of first link attributes of the first map-matched link;
determining whether the second map-matched link is one among the one or more searched downstream links, to obtain a result; and
validating the one or more routes between at least the first road object and the second road object, based on the result.

20. The computer program product of claim 19,
wherein the one or more downstream links comprise a first downstream link and a plurality of second downstream links, and
wherein the searching for the one or more downstream links comprising:
searching for the first downstream link based on the first link attributes; and
iteratively searching for the plurality of second downstream links, based on a plurality of second link attributes of a respective preceding link of each of the plurality of second downstream links.
